(19) United States
(12) Patent Application Publication
(10) Pub. No.: US 2007/0249209 A1
(43) Pub. Date: Oct. 25, 2007

(54) Circuit Arrangement for Coupling a Voltage Supply to a Semiconductor Component, Method for Producing the Circuit Arrangement, and Data Processing Device Comprising the Circuit Arrangement

(76) Inventors: Srdjan Djordjevic, Muenchen (DE); Wolfgang Hoppe, Bad Toelz (DE)

Correspondence Address: SLATER & MATSIL, L.L.P., 17950 PRESTON ROAD, SUITE 1000, DALLAS, TX, 75252, US

(21) Appl. No.: 11/739,573

(22) Filed: Apr. 24, 2007

(30) Foreign Application Priority Data
Apr. 24, 2006 (DE) 10 2006 018 874.8

(51) Int. Cl. H01R 13/62

(52) U.S. Cl. 439/320

(57) ABSTRACT

A circuit arrangement includes an arrangement of layers, wherein the arrangement of layers has a first surface and a second surface, at least one first and at least one second plated-through hole, at least one third plated-through hole, at least one first semiconductor component, and at least one second semiconductor component. A first layer from among the plurality of layers has a first conductive region and a second conductive region, which are coupled via a conductive connection. A second layer from among the plurality of layers has at least one first conductive region coupled to the first plated-through hole, and a second conductive region coupled to the second plated-through hole.

This application claims priority to German Patent Application 10 2006 018 874.8, which was filed Apr. 24, 2006, and is incorporated herein by reference.

### BACKGROUND

Data processing equipment, in particular server systems, may comprise a plurality of memory modules coupled to a control unit of the data processing equipment via a printed circuit board. Buffered memory modules may have a multilayer printed circuit board, a hub chip arranged on a surface of the multilayer printed circuit board, and also a plurality of memory chips, such as random access memory chips (DRAMs), for instance, for storing data, the memory chips being arranged on a surface of the multilayer printed circuit board. Accesses by the control unit to the respective memory modules, such as read and write accesses, for instance, are controlled by the respective hub chip in this case.

An external supply voltage for the hub chips can be passed to respective contact terminals of the memory modules via conductor tracks running in the printed circuit board.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 schematically shows a cross-sectional view of a circuit arrangement in accordance with one embodiment;

FIG. 2 shows a plan view of a section of the first layer 10-6 of the circuit arrangement that is illustrated in FIG. 1;

FIG. 3 shows a plan view of a section of the fourth layer 10-5 of the circuit arrangement that is illustrated in FIG. 1;

FIG. 4 shows a plan view of a section of the second layer 10-10 of the circuit arrangement that is illustrated in FIG. 1;

FIGS. 5 to 9 show a circuit arrangement in different stages of the process for producing the circuit arrangement; and

FIG. 10 shows a data processing device in accordance with one embodiment.

### DETAILED DESCRIPTION OF ILLUSTRATIVE EMBODIMENTS

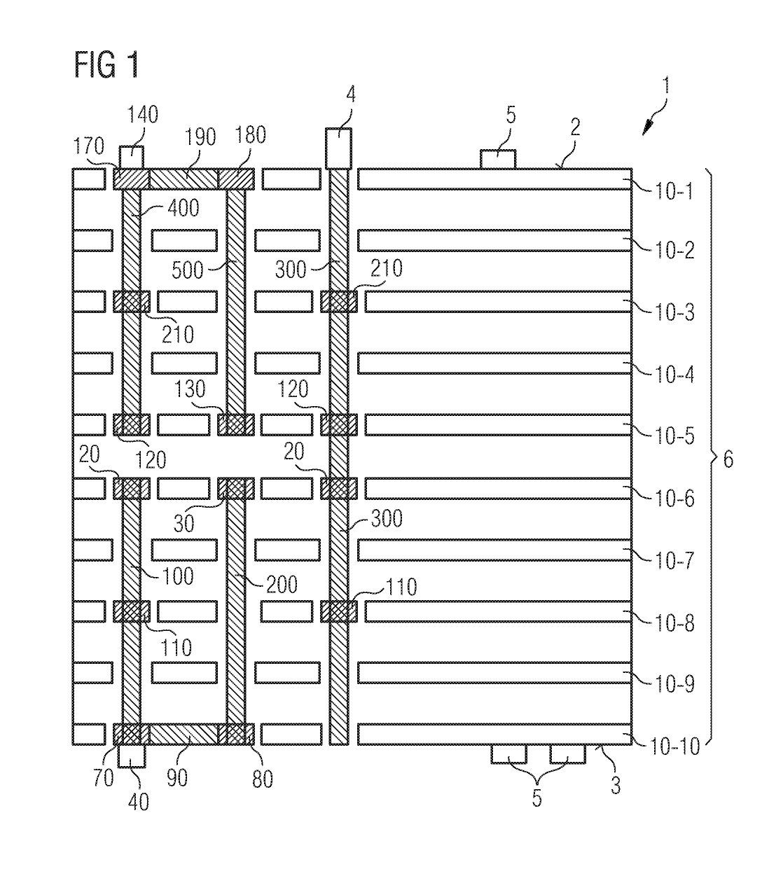

FIG. 1 schematically shows a cross-sectional view of a circuit arrangement in accordance with one embodiment. The circuit arrangement 1 comprises an arrangement of layers 6, the arrangement of layers 6 being formed as a multilayer printed circuit board, for example, and the arrangement of layers 6 having a first surface 2, a second surface 3 remote from the first surface 2, and a plurality of layers 10-1 to 10-10 arranged in an arrangement stacked one above another between the first surface 2 and the second surface 3 of the arrangement of layers 6.

Each of the plurality of layers 10-1 to 10-10 may comprise one or a plurality of patterned conductive conductor tracks. The patterned conductor tracks may comprise a metal, such as copper, for instance. An electrically insulating material (not shown in FIG. 1) is in each case provided between adjacent layers from among the plurality of layers 10-1 to 10-10. The electrically insulating material may comprise glass fiber mats impregnated with epoxy resin. The electrically insulating material may, however, also comprise Teflon, ceramic or polyester film.

A first layer 10-6 from among the plurality of layers 10-10 has a first patterned conductive region 20 and a second patterned conductive region 30. The first patterned conductive region 20 and the second patterned conductive region 30 of the first layer 10-6 are coupled via a conductive connection (not shown in FIG. 1) having a high electrical resistance.

A second layer 10-10 from among the plurality of layers 10-1 to 10-10 is arranged adjacent to the second surface 3 of the arrangement of layers 6. The second layer 10-10 has a first patterned conductive region 70 and a second patterned conductive region 80.

A first plated-through hole 100 extends from the second surface 3 of the arrangement of layers 6 as far as the first layer 10-6 from among the plurality of layers 10-1 to 10-10, the first patterned conductive region 20 of the first layer 10-6 being coupled to the first plated-through hole 100, and the first patterned conductive region 70 of the second layer 10-10 being coupled to the first plated-through hole 100.

A second plated-through hole 200 is furthermore provided, which extends from the second surface 3 of the arrangement of layers 6 as far as the first layer 10-6, the second patterned conductive region 30 of the first layer 10-6 being coupled to the second plated-through hole 200, and the second patterned conductive region 80 of the second layer 10-10 being coupled to the second plated-through hole 200.

The first plated-through hole 100 and the second plated-through hole 200 may in each case extend from the second surface 3 of the arrangement of layers 6 as far as a surface of the first layer 10-6 that is remote from the second layer 10-10.

A third plated-through hole 300 extends from the first surface 2 of the arrangement of layers 6 as far as the second surface 3 of the arrangement of layers 6. The first patterned conductive region 20 of the first layer 10-6 is coupled to the third plated-through hole 300.

A first semiconductor component 4 is arranged on the first surface 2 of the arrangement of layers 6, which component is coupled to the third plated-through hole 300 and is coupled via the third plated-through hole 300 to the first patterned conductive region 20 of the first layer 10-6 from among the plurality of layers. Moreover, at least one second semiconductor component 5 is arranged on the first surface 2 and/or the second surface 3 of the arrangement of layers 6.

The first semiconductor component 4 may comprise a hub chip. The second semiconductor component 5 may comprise, for example, a memory chip comprising dynamic random access memory cells (DRAM) or a memory chip comprising synchronous dynamic random access memory cells (SDRAM).

The circuit arrangement 1 may be formed as a buffered dual inline memory module (DIMM), in which the first semiconductor component 4 controls performance of read and write accesses to the at least one second semiconductor component 5.

A contact terminal 40 for coupling to an external voltage supply is provided on the second surface 3 of the arrangement of layers 6, the contact terminal being coupled to the first conductive region 70 of the second layer 10-10.

The first semiconductor component 4 arranged on the first surface 2 of the arrangement of layers 6 is coupled to the contact terminal 40 via a conductive path comprising the third plated-through hole 300, the first patterned conductive region 20 of the first layer 10-6, the first plated-through hole 100 and the first patterned conductive region 70 of the second layer 10-10.

In order to ensure a functionality of the circuit arrangement 1, an impedance of the conductive path must satisfy specific requirements. By way of example, it may be necessary for the impedance of the conductive path to lie within a range of 4.06 mohms and 5.74 mohms.

The impedance of the conductive path is determined in particular by the configuration of the first patterned conductive region 20 of the first layer 10-6.

On the basis of the process for producing the circuit arrangement 1, the process being explained in more detail with reference to FIGS. 5 to 9, it is possible to vary the layer thickness of the first layer 10-6 and hence the layer thickness of the first patterned conductive region 20 of the first layer 10-6 to an extent such that the impedance of the conductive path is higher than required.

In this case, the first patterned conductive region 70 of the second layer 10-10 can be coupled to the second patterned conductive region 80 of the second layer 10-10 via an optional conductive connection 90. By means of the conductive connection 90, the second patterned conductive region 30 of the first layer 10-6 is also coupled via the second plated-through hole 200 to the contact terminal 40.

Since the second patterned conductive region 30 of the first layer 10-6 is furthermore coupled to the first patterned conductive region 20 of the first layer 10-6 via the conductive connection (not shown in FIG. 1) having a high resistance, a further conductive path is provided between the contact terminal 40 and the third plated-through hole 300. The further conductive path runs parallel to a section of the conductive path that runs between the first patterned conductive region 70 of the second layer 10-10 and the conductive connection (not shown in FIG. 1) provided between the first patterned conductive region 20 of the first layer 10-6 and the second patterned conductive region 30 of the first layer 10-6.

The impedance of a conductive connection between the first semiconductor component 4 and the contact terminal 40 is lowered as a result of the formation of the optional conductive connection 90 between the first patterned conductive region 70 of the second layer 10-10 and the second patterned conductive region 80 of the second layer 10-10.

The coupling between the first semiconductor component 4 and the contact terminal 40 may furthermore be effected via further conductive connections.

By way of example, the arrangement of layers 6 may comprise a third layer 10-8 from among the plurality of layers 10-1 to 10-10, which comprises a patterned conductive region 110, which is coupled via the first plated-through hole 100 and the first patterned conductive region 70 of the second layer 10-10 to the contact terminal 40, and is coupled via the third plated-through hole 300 to the first semiconductor component 4.

In accordance with one embodiment, the first semiconductor component 4 may furthermore be coupled to the external voltage source via a further contact terminal 140 arranged at the first surface 2 of the arrangement of layers 6.

In this case, the arrangement of layers 6 furthermore comprises a fourth layer 10-5 having a first patterned conductive region 120 and a second patterned conductive region 130, the first patterned conductive region 120 and the second patterned conductive region 130 of the fourth layer 10-5 being coupled via a conductive connection (not shown in FIG. 1) having a high electrical resistance.

Furthermore, the arrangement of layers 6 has a fifth layer 10-1 arranged adjacent to the first surface 2 of the arrangement of layers 6, said fifth layer comprising a first patterned conductive region 170 and a second patterned conductive region 180, the first patterned conductive region 170 being coupled to the further contact terminal 140.

The first patterned conductive region 170 of the fifth layer 10-1 is coupled to the first conductive region 120 of the fourth layer 10-5 via a fourth plated-through hole 400 extending from the first surface 2 of the arrangement of layers 6 as far as the fourth layer 10-5.

The second patterned conductive region 130 of the fourth layer 10-5 is coupled to the second patterned conductive region 180 of the fifth layer 10-1 via a fifth plated-through hole 500 extending from the first surface 2 of the arrangement of layers 6 as far as the fourth layer 10-5.

The first patterned conductive region 120 of the fourth layer 10-5 from among the plurality of layers 10-1 to 10-10 is furthermore coupled to the third plated-through hole 300.

The first semiconductor component 4 is therefore coupled to the further contact terminal 140 via a conductive path comprising the third plated-through hole 300, the first patterned conductive region 120 of the fourth layer 10-5, the fourth plated-through hole 400 and the first patterned conductive region 170 of the fifth layer 10-1.

The impedance of a coupling between the first semiconductor component 4 and the further contact terminal 140 can be reduced by the formation of a conductive connection 190 between the first patterned conductive region 170 of the fifth layer 10-1 and the second patterned conductive region 180 of the fifth layer 10-1.

As a result of the formation of the conductive connection 190, the second patterned conductive region 130 of the fourth layer 10-5 is coupled to the further contact terminal 140. Since the second patterned conductive region 130 of the fourth layer 10-5 is furthermore coupled to the first patterned region 120 of the fourth layer 10-5, a further conductive path is provided between the further contact terminal 140 and the plated-through hole.

The coupling between the first semiconductor component 4 and the contact terminal 140 may furthermore be effected via further conductive connections.

By way of example, the arrangement of layers 6 may comprise a sixth layer 10-3 from among the plurality of layers 10-1 to 10-10, which has a patterned conductive region 210 coupled to the fourth plated-through hole 400 and to the third plated-through hole 300.

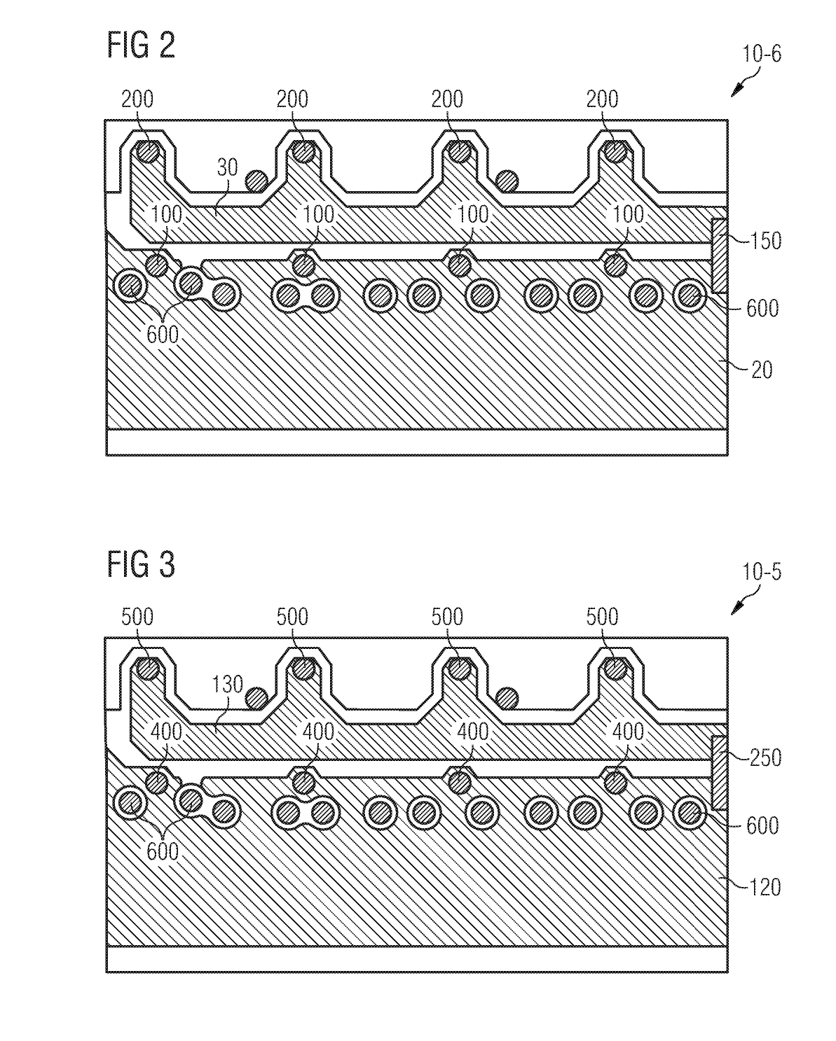

FIG. 2 shows a plan view of a section of the first layer 10-6 illustrated in FIG. 1. The first layer 10-6 has a first patterned conductive region 20 and a second patterned conductive region 30. The first patterned conductive region 20 is coupled to a plurality of first plated-through holes 100. Furthermore, further plated-through holes 600 are provided, but they are not coupled to the first patterned conductive region 20. The further plated-through holes 600 can be coupled to patterned conductive regions of other layers from among the plurality of layers 10-1 to 10-5, 10-7 to 10-10 (not shown in FIG. 2).

The second patterned region 30 is coupled to a plurality of second plated-through holes 200. The first patterned region 20 and the second patterned region 30 are coupled via a conductive connection 150, which may have a high resistance.

FIG. 3 shows a plan view of a section of the fourth layer 10-5 illustrated in FIG. 1. The fourth layer 10-5 has a first patterned conductive region 120 and a second patterned conductive region 130. The first patterned conductive region 120 is coupled to a plurality of fourth plated-through holes 400. Furthermore, further plated-through holes 600 are provided, but they are not coupled to the first patterned conductive region 120. The further plated-through holes 600 can be coupled to patterned conductive regions of other layers from among the plurality of layers 10-1 to 10-4, 10-7 to 10-10 (not shown in FIG. 3).

The second patterned region 130 is coupled to a plurality of fifth plated-through holes 500. The first patterned region 120 and the second patterned region 130 are coupled via a conductive connection 250, which may have a high resistance.

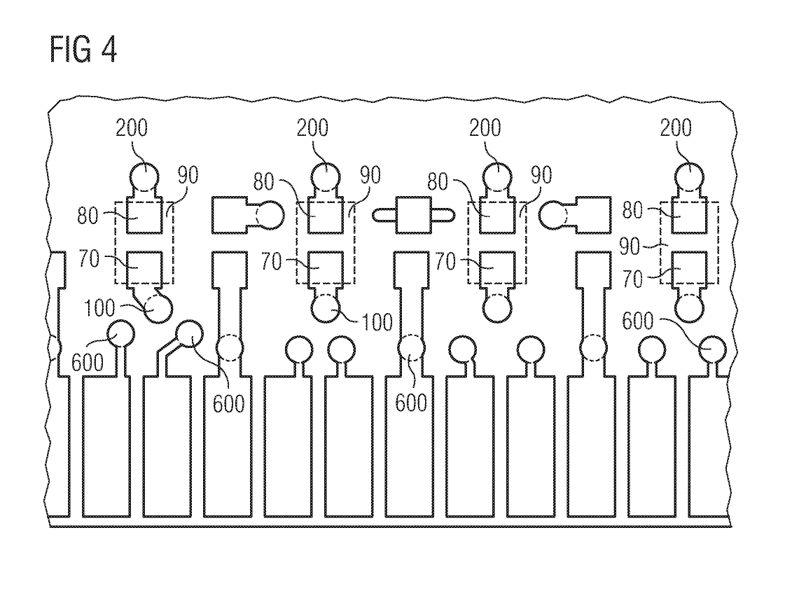

FIG. 4 shows a plan view of a section of the second layer 10-10 of the circuit arrangement 1 shown in FIG. 1. Respective first plated-through holes 100 are coupled to respective first patterned conductive regions 70 of the second layer 10-10. Furthermore, respective second patterned conductive regions 80 are coupled to respective second plated-through holes 200.

For reasons of clarity, the coupling of the contact terminal 40 (not shown in FIG. 4) to respective first patterned conductive regions 70 is not shown in FIG. 4.

Moreover, further plated-through holes 600 are provided, but they are not coupled to the first patterned conductive regions 70 or the second patterned conductive regions 80.

As shown in FIG. 4, respective first patterned regions 70 and second patterned regions 80 may be coupled via an optional conductive connection 90. The conductive connection 90 may be coupled to the first patterned conductive region 70 and the second patterned conductive region 80, for example, by means of a soldering method.

A method for producing a circuit arrangement in accordance with one embodiment is illustrated below with reference to FIGS. 5 to 9.

Referring to FIG. 5, firstly a first conductive layer 1010-1 of a first arrangement of layers 1000 is patterned. The patterning of the first layer 1010-1, in the same way as the patterning steps specified below, may comprise, for example, the formation of a photoresist on the conductive layer, patterning of the photoresist by means of photolithography and subsequent development of the photoresist, and etching of locations of the conductive layer that are not covered by the photoresist.

The first arrangement of layers 1000 has a first surface 1001 and a second surface 1002 remote from the first surface 1001. A plurality of layers 1010-1 to 1010-5 are arranged in an arrangement stacked one above another between the first surface 1001 and the second surface 1002.

Each of the plurality of layers 1010-1 to 1010-5 may comprise one or a plurality of patterned conductive conductor tracks. The patterned conductor tracks may comprise a metal, such as copper, for instance. An electrically insulating material may in each case be provided between adjacent layers from among the plurality of layers 1010-1 to 1010-5. The electrically insulating material may comprise glass fiber mats impregnated with epoxy resin. The electrically insulating material may, however, also comprise Teflon, ceramic or polyester film.

The first layer 1010-1 is arranged adjacent to the first surface 1001 of the first arrangement of layers 1000. The patterning results in formation of a first conductive region 1020, a second conductive region 1030, and a conductive connection (not shown in FIG. 5) having a high resistance between the first conductive region 1020 and the second conductive region 1030 of the first layer 1010-1.

A second layer 1010-5, which is arranged adjacent to the second surface 1002 of the first arrangement of layers 1000, is then patterned. A first patterned conductive region 1070 and a second patterned conductive region 1080 of the second layer 1010-5 are formed in this case.

A first contact hole 1100 is formed, which extends from the first surface 1001 as far as the second surface 1002 of the first arrangement of layers 1000. By way of example, the formation of the first contact hole 1100, like the formation of further contact holes as well, may be effected by means of drilling.

The first contact hole 1100 adjoins the first patterned conductive region 1020 of the first layer 1010-1 and the first patterned conductive region 1070 of the second layer 1010-5.

Furthermore, a second contact hole 1200 is formed, which extends from the first surface 1001 as far as the second surface 1002 of the first arrangement of layers 1000.

The second contact hole 1200 adjoins the second patterned conductive region 1030 of the first layer 1010-1 and the second patterned conductive region 1080 of the second layer 1010-5.

The first 1100 and the second 1200 contact hole are then filled with a conductive material.

Via the first contact hole 1100 filled with the conductive material, a conductive connection is produced between the first conductive region 1020 of the first layer 1010-1 and the first patterned conductive region 1070 of the second layer 1010-5.

Via the second contact hole 1200 filled with a conductive material, a conductive connection is produced between the second conductive region 1030 of the first layer 1010-1 and the second patterned conductive region 1080 of the second layer 1010-5.

In accordance with one embodiment, a third layer 1010-3 situated between the first layer 1010-1 and the second layer 1010-5 may be patterned in such a way that it has a patterned conductive region 1210. A section of the patterned conductive region 1210 can be coupled to the first contact hole 1100 filled with an electrically conductive material.

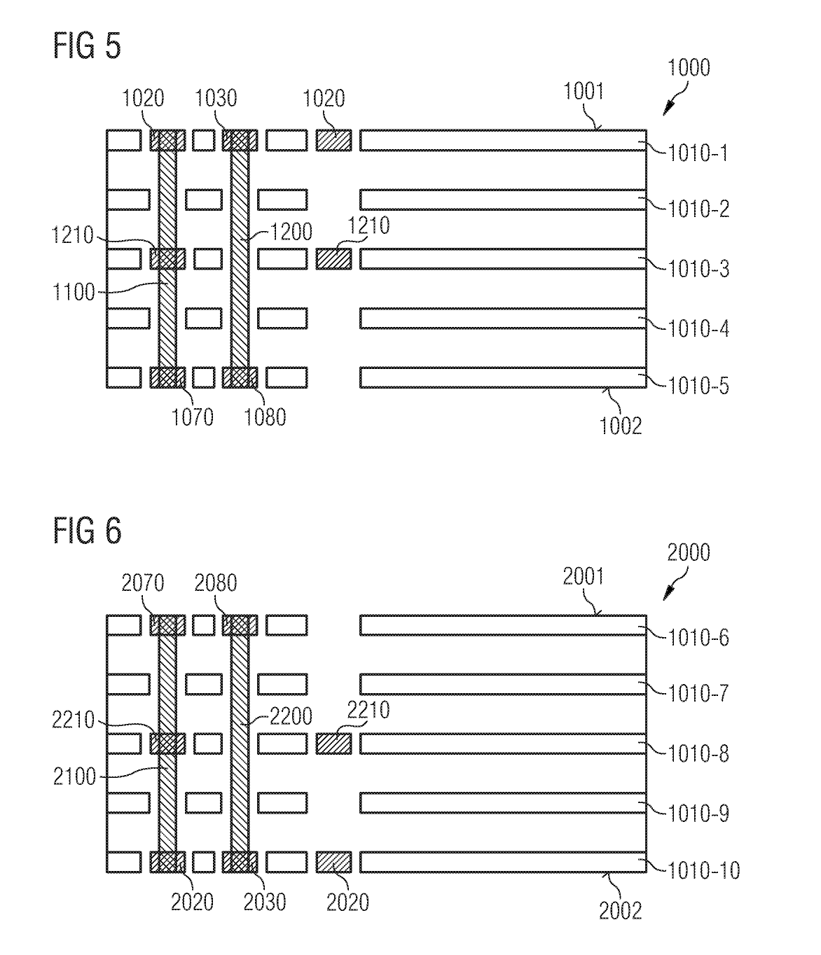

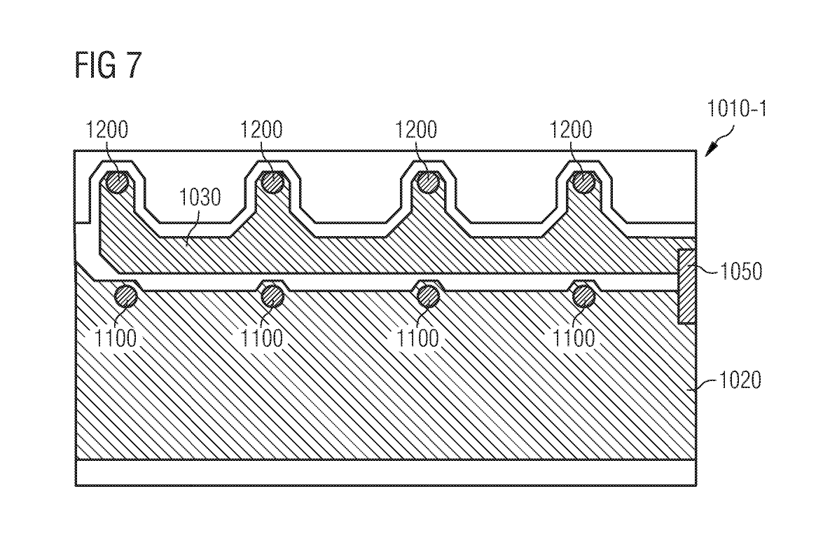

Referring to FIG. 6, a second arrangement of layers 2000 is provided. The second arrangement of layers 2000 is formed as a multilayer printed circuit board, for example, and has a first surface 2001 and a second surface 2002 remote from the first surface 2001. Between the first surface 2001 and the second surface 2002 of the second arrangement of layers 2000, a plurality of layers 1010-6 to 1010-10 are arranged in an arrangement stacked one above another between the first surface 2001 and the second surface 2002. Insulating layers (not shown in FIG. 6) are in each case provided between adjacent layers from among the plurality of layers 1010-6 to 1010-10 of the second arrangement of layers 2000.

FIG. 7 shows a plan view of a section of the first layer 1010-1 of the first arrangement of layers 1000 that is illustrated in FIG. 5. The first layer 1010-1 has a first patterned conductive region 1020 and a second patterned conductive region 1030. The first patterned conductive region 1020 is coupled to a plurality of first contact holes 1100 filled with a conductive material.

The second patterned region 1030 is coupled to a plurality of second contact holes 1200 filled with a conductive material. The first patterned region 1020 and the second patterned region 1030 are coupled via a conductive connection 1050, which preferably has a high resistance.

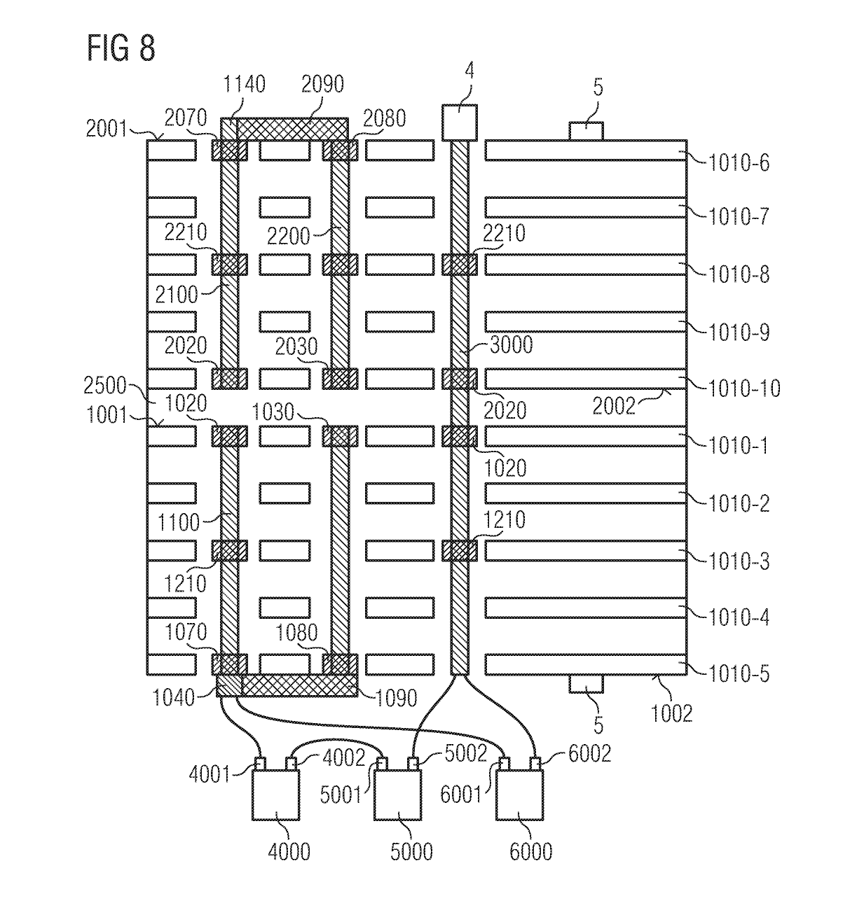

Referring to FIG. 8, in accordance with one embodiment, the second arrangement of layers 2000 and the first arrangement of layers 1000 are then connected by means of an insulating layer 2500 in such a way that the first surface 1001 of the first arrangement of layers 1000 faces the second surface 2002 of the second arrangement of layers 2000. The insulating layer 2500 may be formed on the second surface 2002 of the second arrangement of layers 2000 or on the first surface 1001 of the first arrangement of layers 1000.

A contact hole 3000 is then formed, which extends from the first surface 2001 of the second arrangement of layers 2000 as far as the second surface 1002 of the first arrangement of layers 1000. In this case, the contact hole 3000 adjoins the patterned first conductive region 1020 of the first layer 1010-1 of the first arrangement of layers 1000.

In the case where a third layer 1010-3 of the first arrangement of layers 1000 having a patterned conductive region 1210 is provided, the contact hole 3000 is formed in such a way that it adjoins the patterned region 1210.

The contact hole 3000 is then filled with an electrically conductive material.

A contact terminal 1040 is then formed on the second surface 1002 of the first arrangement of layers 1000, said contact terminal being coupled to the first patterned conductive region 1070 of the second layer 1010-5.

The conductive material of the contact hole 3000 is coupled to the contact terminal 1040 via a conductive path comprising the first patterned conductive region 1020 of the first layer 1010-1 of the first arrangement of layers 1000, the conductive material of the first contact hole 1100 of the first arrangement of layers 1000 and the first patterned conductive region 1070 of the second layer 1010-5 of the first arrangement of layers 1000.

In the case where a third layer 1010-3 of the first arrangement of layers 1000 having a patterned conductive region 1210 is provided, the conductive material of the contact hole 3000 is furthermore coupled to the contact terminal 1040 via a further conductive path comprising the patterned conductive region 1210, the conductive material of the first contact hole 1100 and the first patterned conductive region 1070 of the second layer 1010-5 of the first arrangement of layers.

An impedance between the conductive material of the contact hole 3000 and the contact terminal 1040 is then measured, the impedance being determined by an impedance of the conductive path and, if appropriate, of the further conductive path.

For measuring the impedance, an output 4001 of a voltage source 4000 is coupled to the contact terminal 1040, the conductive material of the contact hole 3000 is coupled to an input 5002 of a current measuring device 5000 and an output 5001 of the current measuring device 5000 is coupled to an input 4002 of the voltage source 4000.

Furthermore, an output 6001 of a voltage measuring device 6000 is coupled to the contact terminal 1040 and an input 6002 of the voltage measuring device 6000 is coupled to the conductive material of the contact hole 3000.

A voltage is then applied between the contact terminal 1040 and the conductive material of the contact hole 3000 by means of the voltage source 4000. A current flowing through the current measuring device 5000 and a voltage present between the input 6002 and the output 6001 of the voltage measuring device 6000 are measured.

From the measured voltage and the measured current, the impedance is then determined by dividing the value of the voltage by the value of the current.

The determined value of the impedance is then compared with a predefined value. If the determined value of the impedance is higher than the predefined value, then a conductive connection 1090 is formed between the first patterned conductive region 1070 and the second patterned conductive region 1080 of the second layer 1010-5 of the first arrangement of layers 1000. Since the second patterned conductive region 1030 of the first layer 1010-1 of the first arrangement of layers 1000 is then also coupled between the conductive material of the contact hole 3000 and the contact terminal 1040, the impedance between the conductive material of the contact hole 3000 and the contact terminal 1040 is reduced.

Finally, a first semiconductor component 4 is arranged on the first surface 2001 of the second arrangement of layers 2000 and is coupled to the conductive material of the contact hole 3000.

Furthermore, at least one second semiconductor component 5 is arranged on the first surface 2001 of the second arrangement of layers 2000 and/or the second surface 1002 of the first arrangement of layers 1000.

The first semiconductor component 4 may comprise a hub chip. The second semiconductor component 5 may comprise, for example, a memory chip comprising dynamic random access memory cells (DRAM) or a memory chip comprising synchronous dynamic random access memory cells (SDRAM).

In accordance with a further embodiment, before the first arrangement of layers 1000 is connected to the second arrangement of layers 2000, referring to FIG. 6, a first layer 1010-6 of the second arrangement of layers 2000 may be patterned, the first layer 1010-6 being arranged adjacent to the first surface 2001 of the second arrangement of layers 2000.

A first patterned conductive region 2070 and a second patterned conductive region 2080 of the first layer 1010-6 of the second arrangement of layers 2000 are formed on account of the patterning of the first conductive layer 1010-6.

A second layer 1010-10, which is arranged adjacent to the second surface 2002 of the second arrangement of layers 2000, is then patterned. The patterning of the second conductive layer 1010-10 results in the formation of a first patterned conductive region 2020, a second patterned conductive region 2030 and a conductive connection (not shown in FIG. 6) having a high resistance between the first patterned conductive region 2020 and the second patterned conductive region 2030 of the second layer 1010-10 of the second arrangement of layers 2000.

A first contact hole 2100 extending from the first surface 2001 as far as the second surface 2002 of the second arrangement of layers 2000 and a second contact hole 2200 extending from the first surface 2001 as far as the second surface 2002 of the second arrangement of layers 2000 are then formed. The first contact hole 2100 adjoins the first patterned conductive region 2070 of the first layer 1010-6 and the first patterned conductive region 2020 of the second layer 1010-10. The second contact hole 2200 adjoins the second patterned conductive region 2080 of the first layer 1010-6 and the second patterned conductive region 2030 of the second layer 1010-10.

The first contact hole 2100 and the second contact hole 2200 of the second arrangement of layers 2000 are then filled with a conductive material.

Via the first contact hole 2100 filled with a conductive material, a conductive connection is provided between the first patterned conductive region 2070 of the first layer 1010-6 and the first patterned conductive region 2020 of the second layer 1010-10.

Via the second contact hole 2200 filled with a conductive material, a conductive connection is provided between the second patterned conductive region 2080 of the first layer 1010-6 and the second patterned conductive region 2030 of the second layer 1010-10.

In accordance with one embodiment, a third layer 1010-8 of the second arrangement of layers 2000, which is situated between the first layer 1010-6 and the second layer 1010-10, may be patterned in such a way that it has a patterned conductive region 2210. A section of the patterned conductive region 2210 can be coupled to the first contact hole 2100 filled with an electrically conductive material.

The formation of the contact hole 3000 as described referring to FIG. 8 is then effected in such a way that the contact hole 3000 adjoins the first patterned conductive region 2020 of the second layer 1010-10 of the second arrangement of layers 2000 and, if appropriate, the patterned conductive region 2210 of the third layer 1010-8 of the second arrangement of layers 2000.

A further contact terminal 1140 is then formed on the first surface 2001 of the second arrangement of layers 2000, said further contact terminal being coupled to the first patterned conductive region 2070 of the first layer 1010-6 of the second arrangement of layers 2000.

A conductive path is formed by the filling of the contact hole 3000 with a conductive material, said conductive path coupling the conductive material of the contact hole 3000 to the further contact terminal 1140. The conductive path comprises the first patterned conductive region 2020 of the second layer 1010-10 of the second arrangement of layers 2000, the conductive material of the first contact hole 2100 of the second arrangement of layers 2000 and the first patterned conductive region 2070 of the first layer 1010-6 of the second arrangement of layers 2000.

In the case where a third layer 1010-8 of the second arrangement of layers 2000 having a patterned conductive region 2210 is provided, the conductive material of the contact hole 3000 is furthermore coupled to the further contact terminal 1140 via a further conductive path comprising the patterned conductive region 2210, the conductive material of the first contact hole 2100 and the first patterned conductive region 2070 of the first layer 1010-6 of the second arrangement of layers 2000.

An impedance between the conductive material of the contact hole 3000 and the further contact terminal 1140 is then determined in accordance with the explanations above.

If the determined value of the impedance is higher than a predefined value, then a conductive connection 2090 is formed between the first patterned conductive region 2070 and the second patterned conductive region 2080 of the first layer 1010-6 of the second arrangement of layers 2000. Since the second patterned conductive region 2030 of the second layer 1010-10 is then also coupled between the conductive material of the contact hole 3000 and the further contact terminal 1140, the impedance between the conductive material of the contact hole 3000 and the further contact terminal 1140 is reduced.

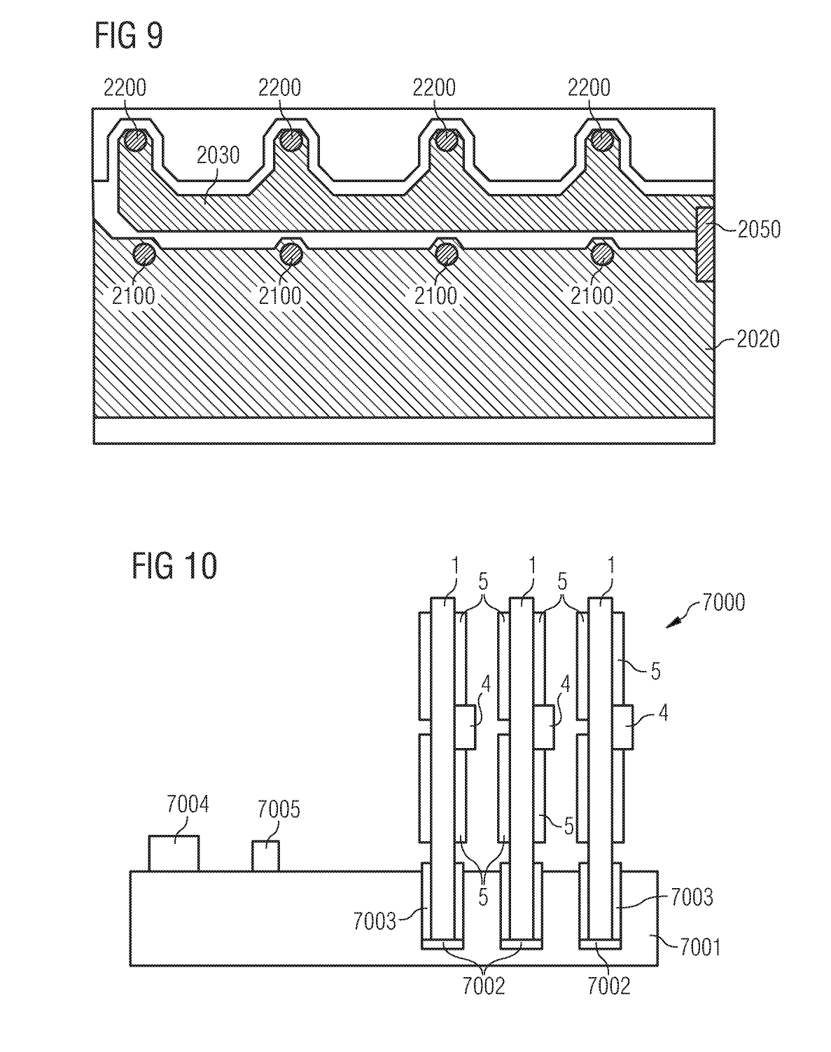

FIG. 9 shows a plan view of a section of the second layer 1010-10 of the second arrangement of layers 2000 that is illustrated in FIG. 6. The second layer 1010-10 has a first patterned conductive region 2020 and a second patterned conductive region 2030. The first patterned conductive region 2020 is coupled to a plurality of first contact holes 2100 filled with a conductive material.

The second patterned region 2030 is coupled to a plurality of second contact holes 2200 filled with a conductive material. The first patterned region 2020 and the second patterned region 2030 are coupled via a conductive connection 2050, which preferably has a high resistance.

FIG. 10 shows a data processing device 7000 in accordance with one embodiment. The data processing device 7000 comprises a printed circuit board 7001, for example, a motherboard, having a plurality of sockets 7002 for receiving in each case a circuit arrangement 1 in accordance with one embodiment. Circuit arrangements 1 in accordance with one embodiment having in each case a first semiconductor component 4 and in each case at least one second semiconductor component 5 are situated in the sockets 7002. Each of the circuit arrangements 1 furthermore has an edge connector 7003 comprising the contact terminal 40 and the further contact terminal 1140 (not shown in FIG. 10).

Furthermore, a control unit 7004 is arranged on the printed circuit board 7001, said control unit being coupled to the respective circuit arrangements 1 via conductor tracks (not shown in FIG. 10) arranged in the printed circuit board 7001 and the respective edge connectors 7003.

A supply voltage is fed to the first semiconductor components 4 of each of the circuit arrangements 1 via a voltage regulator 7005 arranged on the printed circuit board 7001, conductor tracks (not shown in FIG. 10) arranged in the printed circuit board and respective contact terminals 40 and respective further contact terminals 1140 (not shown in FIG. 10).

What is claimed is:

1. A circuit arrangement, comprising an arrangement of layers, wherein the arrangement of layers has a first surface and a second surface and also a plurality of layers arranged in an arrangement stacked one above another between the first surface and the second surface, at least one first plated-through hole, at least one second plated-through hole, at least one third plated-through hole, at least one first semiconductor component and at least one second semiconductor component, wherein:
a first layer from among the plurality of layers has a first conductive region and a second conductive region, which are coupled via a conductive connection having a high electrical resistance;
a second layer from among the plurality of layers has at least one first conductive region coupled to the first plated-through hole, and a second conductive region coupled to the second plated-through hole;
the first conductive region of the first layer from among the plurality of layers is coupled to the first plated-through hole and the second conductive region of the first layer from among the plurality of layers is coupled to the second plated-through hole;
the first semiconductor component is arranged on the first surface and is coupled to the first conductive region of the first layer from among the plurality of layers via the third plated-through hole;
the first plated-through hole and the second plated-through hole each extend from the second surface as far as a surface of the first layer that is remote from the second layer; and
a contact terminal for coupling to a voltage supply is arranged at the second surface and the contact terminal is coupled to the first conductive region of the second layer.

2. The circuit arrangement as claimed in claim 1, wherein the first conductive region and the second conductive region of the second layer from among the plurality of layers are coupled via a conductive connection.

3. The circuit arrangement as claimed in claim 2, wherein a third layer from among the plurality of layers has a conductive region coupled to the first plated-through hole and to the third plated-through hole.

4. The circuit arrangement as claimed in claim 1, furthermore comprising a fourth plated-through hole and a fifth plated-through hole, wherein:
a fourth layer from among the plurality of layers has a first conductive region and a second conductive region, which are coupled via a conductive connection having a high electrical resistance;
a fifth layer from among the plurality of layers has at least one first conductive region coupled to the fourth plated-through hole, and at least one second conductive region coupled to the fifth plated-through hole;
the first conductive region of the fourth layer from among the plurality of layers is coupled to the fourth plated-through hole and the second conductive region of the fourth layer from among the plurality of layers is coupled to the fifth plated-through hole;
the first conductive region of the fourth layer from among the plurality of layers is coupled to the third plated-through hole;
the fourth plated-through hole and the fifth plated-through hole each extend from the first surface as far as a surface of the fifth layer that is remote from the fourth layer; and
a further contact terminal for coupling to a voltage supply is arranged at the first surface and the further contact terminal is coupled to the first conductive region of the fourth layer.

5. The circuit arrangement as claimed in claim 4, wherein the first conductive region and the second conductive region of the fourth layer from among the plurality of layers are coupled via a conductive connection.

6. The circuit arrangement as claimed in claim 4, wherein a sixth layer from among the plurality of layers has a conductive region coupled to the fourth plated-through hole and to the third plated-through hole.

7. The circuit arrangement as claimed in claim 1, wherein the at least one second semiconductor component comprises a memory chip comprising dynamic random access memory cells.

8. The circuit arrangement as claimed in claim 7, wherein the first semiconductor component controls a performance of read and write accesses to the at least one second semiconductor component.

9. The circuit arrangement as claimed in claim 8, wherein the first semiconductor component comprises a hub chip.

10. A method for forming a circuit arrangement, the method comprising:
patterning a first layer of a first arrangement of layers, wherein the first arrangement of layers has a first surface and a second surface and a plurality of layers arranged in an arrangement stacked one above another between the first surface and the second surface, wherein the first layer is arranged adjacent to the first surface, and in the process forming a first conductive region, a second conductive region and a conductive connection between the first conductive region and the second conductive region of the first layer, the conductive connection having a high resistance;
patterning a second layer of the first arrangement of layers, the second layer of the first arrangement of layers being adjacent to the second surface, and as a result forming a first conductive region and a second conductive region of the second layer;
forming a first contact hole extending from the first conductive region of the first layer as far as the first conductive region of the second layer;
forming a second contact hole extending from the second conductive region of the first layer as far as the second conductive region of the second layer;
filling the first contact hole and the second contact hole with a conductive material;
connecting the first arrangement of layers to a second arrangement of layers, wherein the second arrangement of layers has a first surface and a second surface, and in the process forming an insulating layer on the first surface of the first arrangement of layers or on the second surface of the second arrangement of layers;
forming a contact hole that extends from the first surface of the second arrangement of layers as far as the second surface of the first arrangement of layers and adjoins the first conductive region of the first layer of the first arrangement of layers;
filling the contact hole with a conductive material; and
forming a contact terminal at the second surface of the first arrangement of layers and coupling of the contact terminal to the first conductive region of the second layer of the first arrangement of layers.

11. The method as claimed in claim 10, wherein a third layer of the first arrangement of layers comprises a conductive region adjoining the contact hole.

12. The method as claimed in claim 10, further comprising:
coupling an output of a voltage source to the contact terminal;
coupling the conductive material of the contact hole to an input of a current measuring device;
coupling an output of the current measuring device to an input of the voltage source;
coupling an output of a voltage measuring device to the contact terminal;
coupling an input of the voltage measuring device to the conductive material of the contact hole;
applying a voltage by means of the voltage source;
measuring a current flowing through the current measuring device; and
measuring a voltage present between the input and the output of the voltage measuring device.

13. The method as claimed in claim 11, further comprising:
determining a value of an impedance by means of dividing a value of the measured voltage by a value of the measured current;
comparing the determined value of the impedance with a predefined value;
forming a conductive connection between the first conductive region and the second conductive region of the second layer of the first arrangement of layers if the determined value of the impedance is higher than the predefined value.

14. The method as claimed in claim 10, wherein the second arrangement of layers has a plurality of layers arranged in an arrangement stacked one above another between the first surface and the second surface of the second arrangement of layers, the method further comprising:
patterning a first layer of the second arrangement of layers, wherein the first layer is arranged adjacent to the first surface of the second arrangement of layers, and in the process forming a first conductive region and a second conductive region of the first layer;
patterning a second layer of the second arrangement of layers, wherein the second layer is arranged adjacent to the second surface of the second arrangement of layers, and in the process forming a first conductive region, a second conductive region and a conductive connection, which has a high resistance, between the first conductive region and the second conductive region of the second layer of the second arrangement of layers;
forming a first contact hole extending from the first conductive region of the first layer of the second arrangement of layers as far as the first conductive region of the second layer of the second arrangement of layers;
forming a second contact hole extending from the second conductive region of the first layer of the second arrangement of layers as far as the second conductive region of the second layer of the second arrangement of layers;
filling the first contact hole and the second contact hole of the second arrangement of layers with a conductive material; and
forming a further contact terminal at the first surface of the second arrangement of layers and coupling the further contact terminal to the first conductive region of the first layer of the second arrangement of layers.

15. The method as claimed in claim 14, wherein the contact hole adjoins the first conductive region of the second layer of the second arrangement of layers.

16. The method as claimed in claim 15, wherein a third layer of the second arrangement of layers comprises a conductive region adjoining the contact hole.

17. The method as claimed in claim 14, further comprising:
coupling an output of a voltage source to the further contact terminal;
coupling the conductive material of the contact hole to an input of a current measuring device;
coupling an output of the current measuring device to an input of the voltage source;
coupling of an output of a voltage measuring device to the further contact terminal;
coupling an input of the voltage measuring device to the conductive material of the contact hole;
applying a voltage by means of the voltage source;
measuring a current flowing through the current measuring device; and
measuring a voltage present between the input and the output of the voltage measuring device.

18. The method as claimed in claim 17, further comprising:
determining a value of an impedance by means of dividing a value of the measured voltage by a value of the measured current;
comparing the determined value of the impedance with a predefined value; and
forming a conductive connection between the first conductive region and the second conductive region of the first layer of the second arrangement of layers if the determined value of the impedance is higher than the predefined value.

19. The method as claimed in claim 10, further comprising:
arranging a first semiconductor component at the first surface of the second arrangement of layers and coupling the first semiconductor component to the conductive material of the contact hole.

20. The method as claimed in claim 10, further comprising arranging at least one second semiconductor component at the first surface of the second arrangement of layers or at the second surface of the first arrangement of layers.

21. The method as claimed in claim 10, wherein the first semiconductor component comprises a memory chip comprising dynamic random access memory cells.

22. The method as claimed in claim 10, wherein the first semiconductor component comprises a hub chip.

23. A data processing device comprising:
a printed circuit board comprising a plurality of sockets;
a control unit arranged on the printed circuit board;
at least one circuit arrangement comprising an arrangement of layers, wherein the arrangement of layers has a first surface and a second surface and also a plurality of layers arranged in an arrangement stacked one above another between the first surface and the second surface, at least one first plated-through hole, at least one second plated-through hole, at least one third plated-through hole, at least one first semiconductor component and at least one second semiconductor component, wherein:
a first layer from among the plurality of layers has a first conductive region and a second conductive region, which are coupled via a conductive connection having a high electrical resistance;
a second layer from among the plurality of layers has at least one first conductive region coupled to the first plated-through hole, and a second conductive region coupled to the second plated-through hole;
the first conductive region of the first layer from among the plurality of layers is coupled to the first plated-through hole and the second conductive region of the first layer from among the plurality of layers is coupled to the second plated-through hole;
the first semiconductor component is arranged on the first surface and is coupled to the first conductive region of the first layer from among the plurality of layers via the third plated-through hole;
the first plated-through hole and the second plated-through hole each extend from the second surface as far as a surface of the first layer that is remote from the second layer;
a contact terminal for coupling to a voltage supply is arranged at the second surface and the contact terminal being coupled to the first conductive region of the second layer; and
the at least one circuit arrangement has an edge connector and is coupled to the control unit by means of the edge connector.

24. The data processing device as claimed in claim 23, wherein the first conductive region and the second conductive region of the second layer from among the plurality of layers are coupled via a conductive connection.

25. The data processing device as claimed in claim 24, wherein a third layer from among the plurality of layers has a conductive region coupled to the first plated-through hole and to the third plated-through hole.

26. The data processing device as claimed in claim 23, further comprising a fourth plated-through hole and a fifth plated-through hole, wherein:
a fourth layer from among the plurality of layers has a first conductive region and a second conductive region, which are coupled via a conductive connection having a high electrical resistance;
a fifth layer from among the plurality of layers has at least one first conductive region coupled to the fourth plated-through hole, and at least one second conductive region coupled to the fifth plated-through hole;
the first conductive region of the fourth layer from among the plurality of layers is coupled to the fourth plated-through hole and the second conductive region of the fourth layer from among the plurality of layers is coupled to the fifth plated-through hole;
the first conductive region of the fourth layer from among the plurality of layers is coupled to the third plated-through hole;
the fourth plated-through hole and the fifth plated-through hole in each case extend from the first surface as far as a surface of the fifth layer that is remote from the fourth layer; and
a further contact terminal for coupling to a voltage supply is arranged at the first surface and the further contact terminal is coupled to the first conductive region of the fourth layer.

27. The data processing device as claimed in claim 26, wherein the first conductive region and the second conductive region of the fourth layer from among the plurality of layers are coupled via a conductive connection.

28. The data processing device as claimed in claim 26, wherein a sixth layer from among the plurality of layers has a conductive region coupled to the fourth plated-through hole and to the third plated-through hole.

29. The data processing device as claimed in claim 23, wherein the at least one second semiconductor component comprises a memory chip comprising dynamic random access memory cells.

30. The data processing device as claimed in claim 29, wherein the first semiconductor component controls a performance of read and write accesses to the at least one second semiconductor component.

31. The data processing device as claimed in claim 29, wherein the first semiconductor component comprises a hub chip.

32. The data processing device as claimed in claim 23, further comprising:
a voltage regulator arranged on the printed circuit board, wherein the edge connector comprises the contact terminal and the first semiconductor component of the at least one circuit arrangement is coupled to the voltage regulator via the contact terminal.
